(19) United States
(12) Patent Application Publication
(10) Pub. No.: US 2002/0125724 A1
(43) Pub. Date: Sep. 12, 2002

(54) Tumbler Lock

(76) Inventor: Shinghwa Doong, Taipei (TW)

Correspondence Address: Shinghwa Doong, 4F., NO. 16, LANE 6, SEC. 1, Hangchow S. RD, TAIPEI, TW

(21) Appl. No.: 09/803,475

(22) Filed: Mar. 12, 2001

(51) Int. Cl. E05C 1/06

(52) U.S. Cl. 292/144

(57) ABSTRACT

A tumbler lock operatable both electrically and manually either from a remote place or a proximal place is composed of a pair of power supply units each further including a driving motor, a driven wheel, and an actuating strut erected vertically on the profile of the driven wheel following rotating of the driven wheel to actuate a latch to displace thereby unlocking or locking the doors or the windows of private dwellings or public buildings.

### BACKGROUND OF THE INVENTION

(1) Field of the invention

The present invention relates to a tumbler lock, and more particularly, a tumbler lock which can be installed on the door or the window and operatable both electrically and manually to unlock/lock, and furthermore, it can be controlled remotely when being electrically operated.

(2) Description of the Prior Art

Locks are widely used in every life for protecting private property from burglary by installing them on doors and windows of a building where occurrence of illegal ingression is most frequent. Application of locks will satisfactorily attain the aim of isolating indoor side from outside so as to keep away unauthorized breaking in.

An most widely used manually operated lock has a handle bar, a knob or an actuating strap attached to the lock core to displace a latch thereby unlocking or locking the lock. However, it is inconvenient that a lock can only be operated manually, for example, in a large building where the gate and the building is spaced by a broad front yard, it is pretty tiresome to unlock or lock the gate manually for a janitor or a house keeper. For this reason, a more convenient lock is definitely necessary.

### SUMMARY OF THE INVENTION

Accordingly, it is an object of the present invention to provide a tumbler lock which can be remotely operated so as to eliminate inconvenience in operation of a conventional lock.

To achieve this object, the tumbler lock provided in the present invention has an electrically operatable function in addition to the inherent function of manual operation. For this, a pair of power supply units is provided in a lock housing each composed of a driving motor, a driven wheel, and an actuating strut erected vertically on the profile of the driven wheel following rotation of the driven wheel to actuate a latch to displace thereby able to unlock or lock a door or a window. In the meanwhile, this pair of power supply units is disposed facing against each other so as to lock or unlock the lock mechanism respectively.

To enable further understanding of the innovative and technological content of the invention herein, refer to the detailed description of the invention and the accompanying brief description of the drawings appended below.

### BRIEF DESCRIPTION OF THE DRAWINGS

FIG. 1 is a planar disposing view of component parts of the tumbler lock according to the present invention.

FIG. 2 is a bottom view of the tumbler lock of the present invention.

FIG. 3 is a three dimensional exploded view of the operational lever for the tumbler lock according to the present invention.

FIG. 4 is an illustrative view wherein the tumbler lock is in electrically unlocked state.

FIG. 5 is an illustrative view wherein the tumbler lock is in electrically locked state.

### DETAILED DESCRIPTION OF THE PREFERRED EMBODIMENT

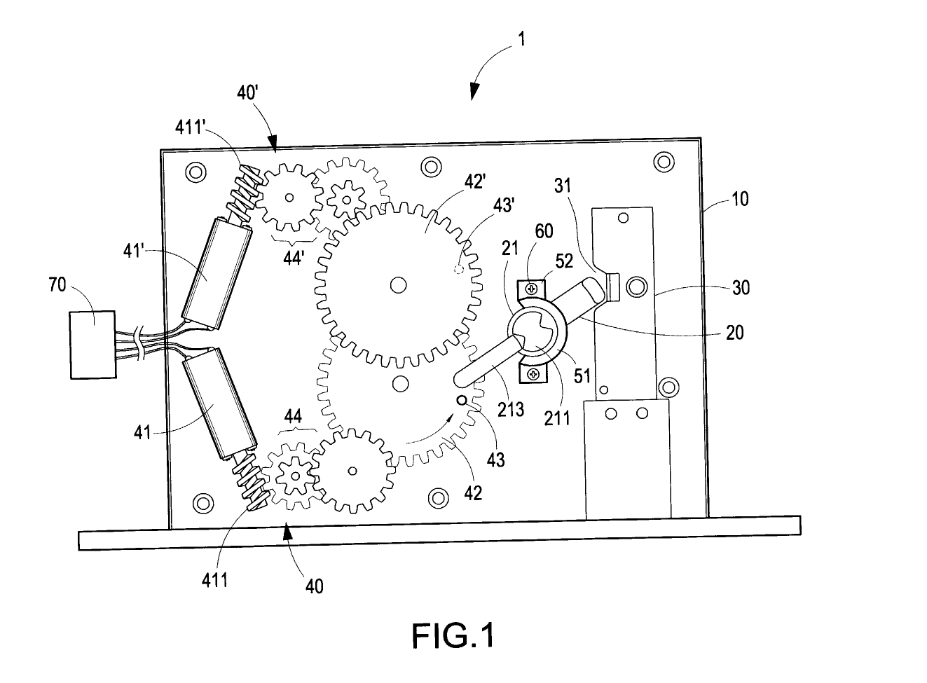

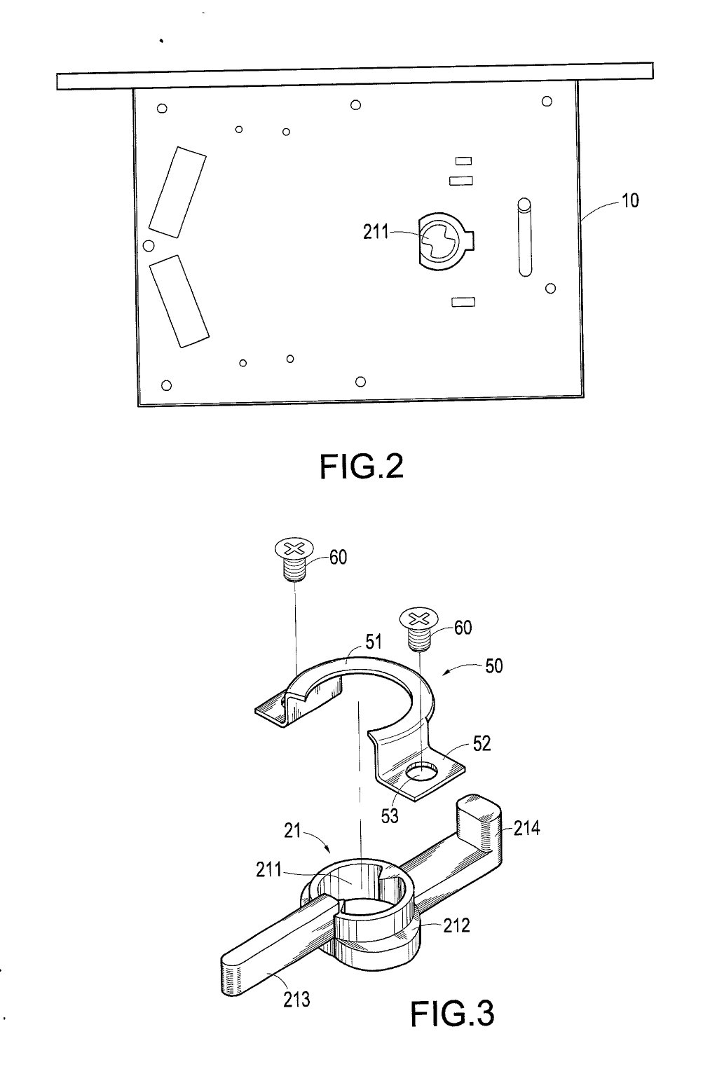

Referring to FIGS. 1 and 2, the two drawings show the planar and bottom views of the tumbler lock according to the present invention. The tumbler lock applicable for locking doors or windows comprises an operational lever 20 pivoted its one end in the lock housing 1 on its base thereof, and a latch 30 for locking or unlocking the tumbler lock by actuation of the operational lever 20 which is provided with a containment hole 211 for conjoining with a knob or latch plate (not shown) to operate lever 20 manually.

In addition to manual operation, the lock of the present invention is operatable electrically by provision of a pair of power supply units 40 and 40′ in the lock housing 1. As shown in FIG. 1, each power supply unit 40 or 40′ is respectively composed of a driving motor 41 or 41′, a driven wheel 42 or 42′ driven by the motor 41 or 41′, and an actuating strut 43 or 43′ erected vertically on the profile of respectively driven wheel 42 or 42′ near the wheel rim so as to revolve together with the rotation of the driven wheel 42 or 42′. In operation, power output of the motor 41 or 41′ is transmitted by a rotational speed reducer 44 or 44′ interposed between the motor 41 or 41′ and the driven wheel 42 or 42′ so as to reduce rotational speed and intensify output torque of the driven wheel 42 or 42′. Both speed reducers 44 and 44′, and driven wheels 42 and 42′are permitted to be composed of several number of external spur gear units so that a relevant output torque can be obtained. The power transmission between the motor 41 or 41′ and the speed reducer 44 or 44′ is carried out by a screw bolt 411 or 411′.

FIG. 3 shows a three dimensional exploded view of the operational lever 20. As shown in FIG. 3, the operational lever 20 has the above mentioned containment hole 211 at its center position, and its main body 21 has an outwardly emerged pressure exerted base 212, a thrust member 213 and a thrust member 214 respectively extended to opposite direction. Operational lever 20 is positioned by a stopper 50 which has a stop collar 51 straddling on the pressure exerted base 212, and is fixed to the housing 10 with two screws 60 passing through two screw fitting holes 53 bored on the two lugs 52 protruded out from two sides such that the operational lever 20 is screw engaged onto the housing 10 with the thrust member 214 just located in a breach 31 formed at an lateral edge of the latch 30, besides, the thrust member 213 is extended to a position whereat it can be actuated by the actuating struts 43 and 43′.

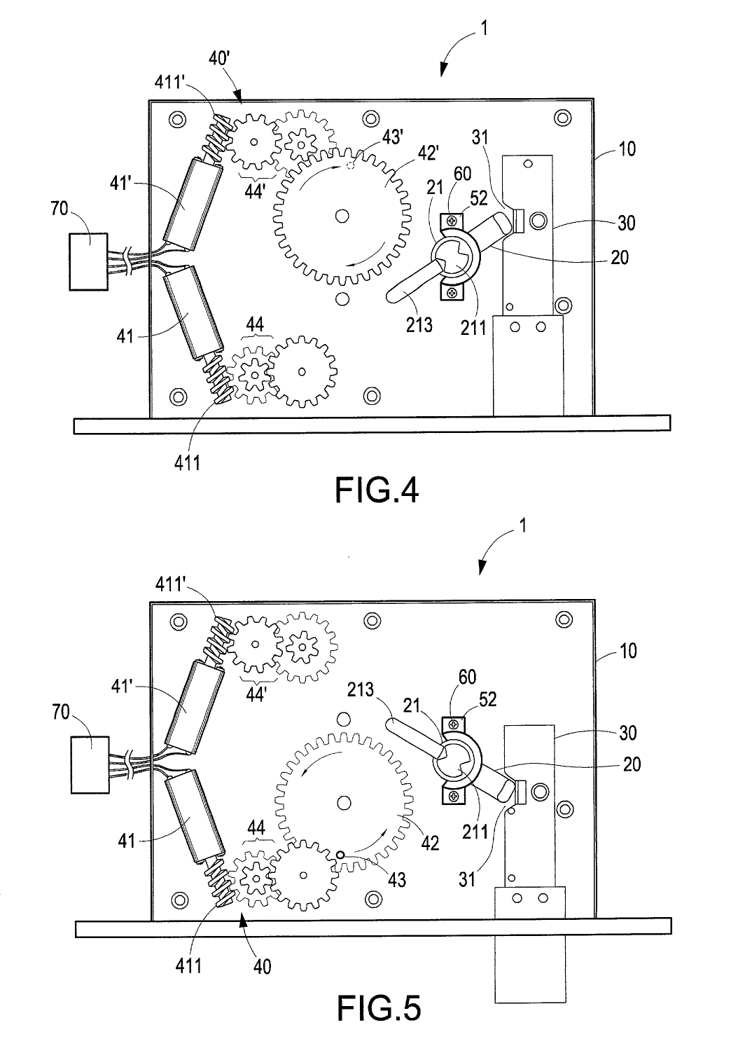

With this structure and by oppositely disposing two power supply units 40 and 40′, the two actuating struts 43 and 43′ actuate the operational lever 20 in an opposite direction resulting in that the latch 30 is driven to be released in unlocking direction or latched in locking direction. Referring to FIG. 4, the drawing shows that the tumbler lock is in electrically unlocked state, the motor 41′ of the upper power supply units 40′ is connected to a controller 70 with conductors, the output power is transmitted to the driven wheel 42′ via the speed reducer 44′, as a result, the driven wheel 42′ turning in clockwise direction causes its actuating strut 43′ to impinge the thrust member 213, at this moment the operational lever 20 turns to cause the thrust member 214 emerging the latch 30 out of the housing 10 therefore the door is locked. On the contrary, when it is desired to unlock the tumbler lock in electrically locked state as shown in FIG. 5, the necessary operation is carried out by the motor 41, the driven wheel 42 rotating in counter clockwise direction, and the actuating strut 43 so as to retract the latch 30 into the housing 10 thereby restoring the unlocked state shown in FIG. 4.

It emerges from the description of the above example that the invention has several noteworthy advantages, particularly, it is both manually and electrically operatable either remotely or proximally so that the tumbler lock of the present invention is widely applicable for windows, doors and gates of private dwellings or public buildings, while it will be apparent that the preferred embodiment of the invention disclosed is well calculated to provide the advantages and features above stated, it will be appreciated that the invention is susceptible to modification, variation and change without departing from the proper scope or fair meaning of the subjoined claims.

What is claimed is:

1. A manually and electrically operated tumbler lock comprising an operational lever pivoted to a lock housing, and a latch for locking and unlocking said tumbler lock by actuation of said operational lever which being provided with a containment hole for conjoining with a knob or a latch plate to operate said lever manually, said tumbler lock is characterized in that it is equipped with a pair of power supply units, each unit is composed of a driving motor, a driven wheel driven by said motor, and an actuating strut erected vertically on the profile of said driven wheel near the wheel rim so as to revolve together with the rotation of said driven wheel to impinge said operational lever, wherein said pair of power supply units is disposed oppositely facing against each other such that said actuating strut of said respective power supply unit is able to impinge said operational lever towards opposite direction thereby causing said latch to perform unlocking or locking mission.

2. The tumbler lock as claimed in claim 1, wherein said operational lever is pivoted in said lock housing and positioned by a stopper secured to said housing.

3. The tumbler lock as claimed in claim 1, wherein each said power supply unit is equipped with a rotational speed reducer interposed between said driving motor and said driven wheel.

4. The tumbler lock as claimed in claim 3, wherein each said rotational speed reducer is formed of several number of external spur gear units.

5. The tumbler lock as claimed in claim 1, wherein each said driven wheel is a gear wheel.

6. The tumbler lock as claimed in claim 1, wherein each said driving motor is connected to an external controller by an electrical conductor.
